(19) United States
(12) Patent Application Publication
(10) Pub. No.: US 2024/0365383 A1
(43) Pub. Date: Oct. 31, 2024

(54) DYNAMIC CHANNEL SWITCH OPERATION

(71) Applicant: NXP USA, INC., Austin, TX (US)

(72) Inventors: Liwen CHU, San Ramon, CA (US); Rui CAO, Sonnyvale, CA (US); Kiseon RYU, San Diego, CA (US); Huizhao WANG, San Jose, CA (US); Hongyuan ZHANG, Fremont, CA (US)

(21) Appl. No.: 18/644,734

(22) Filed: Apr. 24, 2024

Related U.S. Application Data
(60) Provisional application No. 63/498,095, filed on Apr. 25, 2023.
(60) Provisional application No. 63/606,195, filed on Dec. 5, 2023.

(51) Int. Cl. H04W 74/0816; H04L 1/00; H04W 74/08

(52) U.S. Cl. CPC H04W 74/0816; H04L 1/0068; H04W 74/0866

(57) ABSTRACT

A method of method of dynamic channel switching by a station (STA), including: receiving a resource unit (RU) allocation in an initial frame exchange; determining that the STA cannot operate in its operating BW covering a primary channel based upon the RU allocation; switching to secondary channel(s) per an RU allocated to it to carry out communication by the STA during a transmit opportunity (TXOP); carrying out the communication during the TXOP; and switching back to the primary channel no later than an end of the TXOP if detecting that an AP will not do the initial frame exchange with it in the secondary channel(s) within the TXOP.

### CROSS-REFERENCE TO RELATED APPLICATIONS

This application claims the benefit of U.S. Provisional Patent Application No. 63/498,095, filed Apr. 25, 2023 and U.S. Provisional Patent Application No. 63/606,195, filed Dec. 5, 2023, the contents of which are incorporated for all purposes by reference herein in its entirety.

### FIELD OF THE DISCLOSURE

Various exemplary embodiments disclosed herein relate to dynamic channel switch operation in wireless networks.

### BACKGROUND

In a transmission opportunity (TXOP), an access point (AP) as the TXOP holder can request one or multiple stations (STAs) whose operating channel is narrower than the basic service set (BSS) operating channel bandwidth (BW) to switch to the secondary channel to do the frame exchanges with the AP.

### SUMMARY

A summary of various exemplary embodiments is presented below.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method of method of dynamic channel switching by a station (STA). The method also includes receiving a resource unit (RU) allocation in an initial frame exchange. The method also includes determining that the STA cannot operate in its operating BW covering a primary channel based upon the RU allocation. The method also includes switching to secondary channel(s) per an RU allocated to it to carry out communication by the STA during a transmit opportunity (TXOP). The method also includes carrying out the communication during the TXOP. The method also includes switching back to the primary channel no later than an end of the TXOP if detecting that an ap will not do the initial frame exchange with it in the secondary channel(s) within the TXOP. Other embodiments of this aspect include corresponding computer systems, apparatus, and computer programs recorded on one or more computer storage devices, each configured to perform the actions of the methods.

Implementations may include one or more of the following features. The method may include: negotiating by the STA whether the STA enables dynamic channel switching, parking channel(s) after switching to secondary channel(s) where each parking channel includes one or multiple secondary channels; and announcing a padding delay for switching to the secondary channel and a switch delay from the secondary channel back to the primary channel. The method may include: each parking channel has a same bandwidth as the STA's operating BW. The method may include: each parking channel has a narrower bandwidth than the STA's operating BW. STA carries out a dynamic channel switch when the STAs operating bandwidth is narrower than a basic service set bandwidth. The STA has a bandwidth associated with a basic network allocation vector (nav) timer. A received physical layer convergence protocol (PLCP) protocol data unit (PPDU) bandwidth is from another basic service set (BSS) and is greater than the bandwidth associated with the basic nav timer, set the bandwidth associated with the basic nav time to a received STA bandwidth. A duration information in a media access control (mac) header and/or Phy header of a received PPDU from another BSS is greater than a remaining time of the basic nav timer, set the remaining time of the basic nav timer to the duration information in mac header and/or Phy header of the received PPDU. The method if the basic nav timer of a STA has non-zero remaining time and has the bandwidth that can cover an allocated RU that request STA's dynamic channel switch, the STA does not do a dynamic channel switch. The method may include carrying out a dynamic channel puncture during the initial frame exchange that solicits the dynamic channel switching. If a 20 MHz channel is not punctured in the initial frame exchange that solicits the dynamic channel switching, the 20 MHz channel is not punctured in a following frame exchanges of the TXOP. The method may include specifying an anchor channel that is a secondary channel; and carrying out a dynamic channel puncture for secondary channels other than the anchor channel during the initial frame exchange that solicits the dynamic channel switching and a following frame exchanges of the TXOP. The initial frame exchange uses a multi-user request to send message to solicit CTS as the initial frame exchange to initiate a dynamic channel switch. The STA transmits a contention free end (CF-end) message after switching to the secondary channel when the STA does not receive a following physical layer convergence protocol (PLCP) protocol data unit from an access point after the initial frame exchange. The initial frame exchange uses a buffer status report poll (BSRP) trigger message to solicit a quality of service (QOS) null as the initial frame exchange to initiate a dynamic channel switch. Each frame exchange after the initial frame exchange always covers the primary channel with primary channel being not punctured. The STA does not perform media synchronization after switching back to the primary channel. The initial frame exchange uses a double multi-user request to send plus clear to send messages followed by a buffer status report poll (BSRP) trigger message plus a quality of service null message to initiate a dynamic channel switch. The STA switches back to the primary channel after the TXOP ends. The STA is not an enhanced multi-link single radio (EMLSR) STA. The STA is an enhanced multi-link single radio (EMLSR) STA. The STA switches back to the primary channel after the STA detects a failed frame exchange with it, or detects a frame exchange that does not include it. Implementations of the described techniques may include hardware, a method or process, or computer software on a computer-accessible medium.

One general aspect includes an station (STA) for communicating with an access point (ap). The station also includes receive a resource unit (RU) allocation in an initial frame exchange. The station also includes determine that the STA cannot operate in its operating BW covering a primary channel based upon the RU allocation. The station also includes switch to secondary channel(s) per an RU allocated to it to carry out communication by the STA during a transmit opportunity (TXOP). The station also includes carry out the communication during the TXOP. The station also includes switch back to the primary channel no later than an end of the TXOP if detecting that the ap will not do the initial frame exchange with it in a secondary channel(s) within the TXOP. Other embodiments of this aspect include corresponding computer systems, apparatus, and computer programs recorded on one or more computer storage devices, each configured to perform the actions of the methods.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts a multi-link communications system 10 that is used for a wireless network.

FIG. 2 illustrates a context for dynamic channel switch operation.

FIG. 3 illustrates the BSS operating channel with on resource unit (RU) being assigned as the primary channel with the remaining 20 MHz RUs being assigned as the 2nd to the 8th secondary channels.

FIG. 4 illustrates a situation where there is a dynamic channel puncture when a dynamic channel switch occurs.

FIG. 6 illustrates the use of a MU-RTS frame as a control frame for initiating a dynamic channel switch.

FIG. 7 illustrates the use of a BSRP/bandwidth query report poll (BQRP) trigger as a control frame for initiating the dynamic channel switch.

FIG. 8 illustrates a Double MU-RTS+CTS or MU-RTS+CTS followed by BSRP/BQRP Trigger+QoS Null.

FIG. 9 illustrates how the STAs transmit a contention free end (CF-End).

FIG. 10 illustrates a primary channel restriction under DSO.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of wireless networks with an AP soliciting dynamic channel switch of its associated STAs where the AP and STA will affiliated with AP MLD and non-AP MLDs respectively will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

Several aspects of WiFi systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

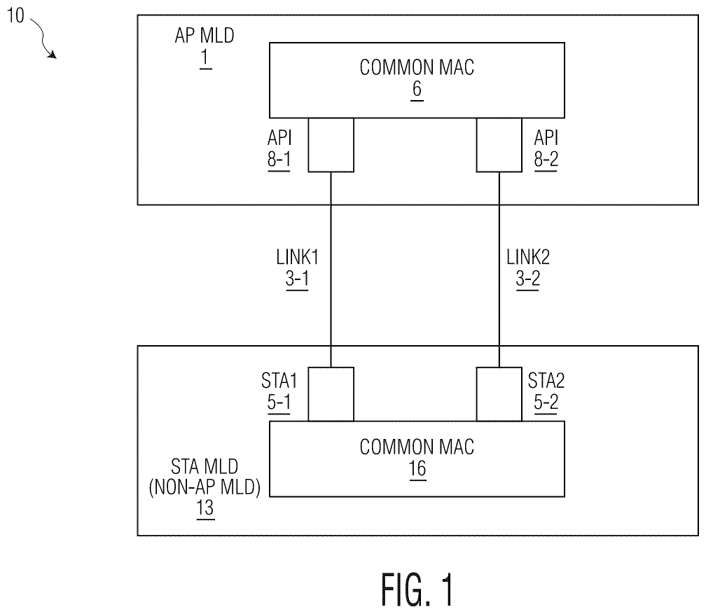

FIG. 1 depicts a multi-link communications system 10 that is used for wireless (e.g., WiFi) communications. In the embodiment depicted in FIG. 1, the multi-link communications system includes one AP multi-link device, which is implemented as AP MLD 1, and one non-AP STA multi-link device, which is implemented as STA MLD (non-AP MLD) 13. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Various iterations of the 802.11 specification are referred to herein. IEEE 802.11ac is referred to as very high throughput (VHT). IEEE 802.11ax is referred to as high efficiency (HE). IEEE 802.11be is referred to as extreme high throughput (EHT). IEEE 802.11bn is referred to as ultra-high reliability (UHR). The terms VHT, HE, EHT, and UHR will be used in the descriptions found herein.

Although the depicted multi-link communications system 10 is shown in FIG. 1 with certain components and described with certain functionality herein, other embodiments of the multi-link communications system may include fewer or more components to implement the same, less, or more functionality. For example, in some embodiments, the multi-link communications system includes a single AP MLD and multiple associated STA MLDs, or multiple AP MLDs and multiple STA MLDs with each STA MLD being associated with an AP MLD. In some embodiments, the legacy STAs (non-HE STAs) associate with one of the APs affiliated with the AP MLD. In some embodiment an AP MLD may have a single affiliated AP. In some embodiment a STA MLD may have a single affiliated STA. In another example, although the multi-link communications system is shown in FIG. 1 as being connected in a certain topology, the network topology of the multi-link communications system is not limited to the topology shown in FIG. 1.

In the embodiment depicted in FIG. 1, the AP MLD 1 includes a common MAC 6 and two APs 8-1, 8-2 in two links. In such an embodiment, the APs may be AP1 8-1 and AP2 8-2. In some embodiments, a common MAC 6 of the AP MLD 1 implements upper layer Media Access Control (MAC) functionalities (e.g., association establishment, reordering of frames, etc.) and a link specific part of the AP MLD 1, i.e., the APs 8-1 and 8-2, implement lower layer MAC functionalities (e.g., backoff, frame transmission, frame reception, etc.), PHY layer functionalities, radios. The APs 8-1 and 8-2 may be implemented in hardware (e.g., circuits), software, firmware, or a combination thereof. The APs 8-1 and 8-2 may be fully or partially implemented as an integrated circuit (IC) device. In some embodiments, the APs 8-1 and 8-2 may be wireless APs compatible with at least one WLAN communications protocol (e.g., at least one IEEE 802.11 protocol). For example, the APs 8-1 and 8-2 may be wireless APs compatible with the IEEE 802.11bn protocol.

In some embodiments, an AP MLD (e.g., AP MLD 1) connects to a local area network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiment, an AP (e.g., AP1 8-1 and/or AP2 8-2) includes multiple RF chains. In some embodiments, an AP (e.g., AP1 8-1 and/or AP2 8-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 8-1 or 8-2 of the AP MLD 1 with multiple RF chains may operate in a different basic service set (BSS) operating channel (in a different link). For example, AP1 8-1 may operate in a 320 MHz BSS operating channel at 6 GHz band, and AP2 8-2 may operate in a 160 MHz BSS operating channel at 5 GHz band.

In the embodiment depicted in FIG. 1, the non-AP STA multi-link device, implemented as STA MLD 13, includes a common MAC 16, two non-AP STAs 5-1 and 5-2 in two links. In such an embodiment, the non-AP STAs may be STA1 5-1 and STA2 5-2. The STAs 5-1 and 5-2 may be implemented in hardware (e.g., circuits), software, firmware, or a combination thereof. The STAs 5-1 and 5-2 may be fully or partially implemented as an IC device. In some embodiments, the non-AP STAs 5-1 and 5-2 are part of the STA MLD 13, such that the STA MLD may be a communications device that wirelessly connects to a wireless AP MLD. For example, the STA MLD 13 may be implemented in a laptop, a desktop personal computer (PC), a mobile phone, or other communications device that supports at least one WLAN communications protocol. In some embodiments, the non-AP STA MLD 13 is a communications device compatible with at least one IEEE 802.11 protocol (e.g., an IEEE 802.11bn protocol, an IEEE 802.11be protocol, an IEEE 802.11ax protocol, or an IEEE 802.11ac protocol). In some embodiments, the STA MLD 13 implements a common MAC functionality 16 and the non-AP STAs 5-1 and 5-2 implement a lower layer MAC data functionality, PHY functionalities.

In some embodiments, the AP MLD 1 and/or the STA MLD 13 may identify which communication links support multi-link operation during a multi-link operation setup phase and/or exchanges information regarding multi-link capabilities during the multi-link operation setup phase. In some embodiments, each of the non-AP STAs 5-1 and 5-2 of the STA MLD 13 in different link may operate in a different frequency band. For example, the non-AP STA1 5-1 in one link may operate in the 2.4 GHz frequency band and the non-AP STA2 5-2 in another link may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 1, the STA MLD 13 communicates with the AP MLD 1 via two communication links, e.g., link 1 3-1 and link 2 3-2. For example, each of the non-AP STAs 3-1 or 3-2 communicates with an AP 8-1 or 8-2 via corresponding communication links 3-1 or 3-2. In an embodiment, a communication link (e.g., link 1 3-1 or link 2 3-2) may include a BSS operating channel established by an AP (e.g., AP1 8-1 or AP2 8-2) that features multiple 20 MHz channels used to transmit frames (e.g., Beacon frames, management frames, etc.) being carried in Physical Layer Convergence Protocol (PLCP) Protocol Data Units (PPDUs) between a first wireless device (e.g., an AP, an AP MLD, an STA, or an STA MLD) and a second wireless device (e.g., an AP, an AP MLD, an STA, or an STA MLD). In some embodiments, a 20 MHz channel may be a punctured 20 MHz channel or an unpunctured 20 MHz channel. Although the STA MLD 13 is shown in FIG. 1 as including two non-AP STAs, other embodiments of the STA MLD 13 may include one non-AP STA or more than two non-AP STAs. In addition, although the AP MLD 1 communicates (e.g., wirelessly communicates) with the STA MLD 13 via multiple links 3-1 and 3-2, in other embodiments, the AP MLD 1 may communicate (e.g., wirelessly communicate) with the STA MLD 13 via more than two communication links or less than two communication links.

As described above a multi-link AP MLD has one or multiple links where each link has one AP affiliated with the AP MLD. This may be accomplished by having the different radios for the different affiliated APs.

A multi-link STA MLD has one or multiple links where each link has one STA affiliated with the STA MLD. One way to implement the multi-link STA MLD is using two or more radios, where each radio is associated with a specific link. For example, an multi-link multi-radio (MLMR) non-AP MLD may be used. The MLMR non-AP MLD uses multiple full functional radios to monitor the medium in multiple links. Another way to implement the multi-link STA MLD is using a single radio in two different bands. Each band may be associated with a specific link. In this case only one link is available at a time. In yet another implementation, an enhanced single-radio (ESR) STA MLD may be used that operates in an enhanced multi-link single radio (eMLSR) mode. The ESR STA MLD uses two radios in different bands to implement the MLD. For example, one radio may be a lower cost radio with lesser capabilities and the other radio may be a fully functional radio supporting the latest protocols. The ESR STA MLD may dynamically switch its working link while it can only transmit or receive through one link at any time. The ESR STA MLD may monitor two links simultaneously, for example, detecting medium idle/busy status of each link, or receiving a PPDU on each link. Each radio may have its own backoff time, and when the backoff counter for one of the radios becomes zero that radio and link may be used for transmission. For example, if an AP wants to use the fully functional radio, it may send a control frame that is long enough for the ESR STA MLD to switch from the lesser capable radio to the fully functional radio that may then transmit data to the AP. When an ESS includes multiple AP MLDs in different locations and a STA MLD executed the data frame exchanges with one of the AP MLDs (say AP MLD1), as the STA MLD's associated AP MLD moves to other location to do the data frame exchanges with another one of the AP MLDs (say AP MLD2), the STA MLD (same as a non-AP MLD herein) needs to finish the association with AP MLD2 before doing the data frame exchanges with AP MLD2. There is a requirement to decrease the number of associations within the ESS.

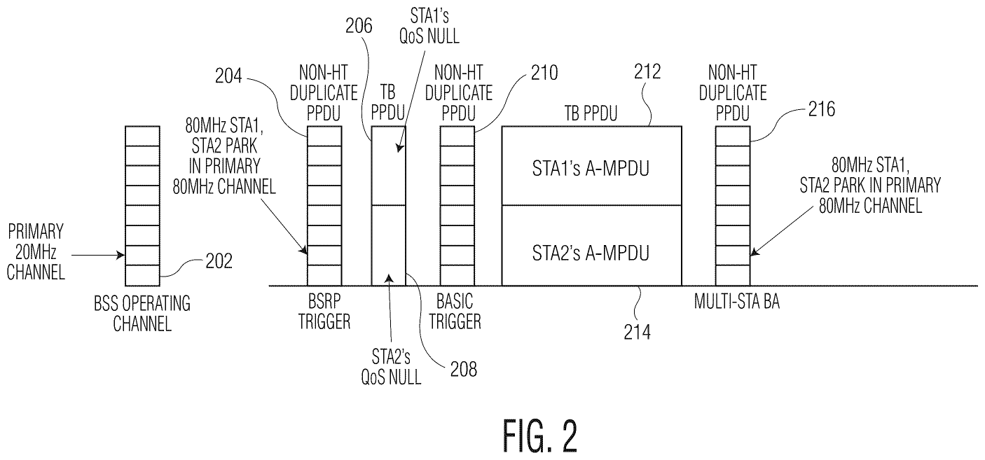

Dynamic Channel Switch Operation (DSO) is when in a TXOP, an AP as the TXOP holder can request one or multiple STAs whose operating channel is narrower than the BSS operating channel BW and the TXOP BW to switch to the secondary 20 MHz channel(s) that is/are not covered the STA(s)'s operating BW to do the frame exchanges with the AP. The STAs switching to the secondary 20 MHz channel(s) switch back to the primary channel at the end of the TXOP. The (modified) multi-user request to send a (MU-RTS) message (or MU-RTS as the initiating control frame) plus the clear to send (CTS) message and a modified buffer status report poll (BSRP) Trigger message (or BSRP Trigger as the initiating control frame) plus a Quality of Service (QOS) Null message (or Multi-STA BA) may be used to request a STA's dynamic channel switch. FIG. 2 illustrates a context for dynamic channel switch operation. In this example the BSS has an 160 MHz BSS operating channel 202. The 80 MHz stations STA1 and STA2 may park in the BSS operating channel 202. The AP may send out a BSRP trigger signal 204 to initiate communication with STA1 and STA2. The BSRP trigger signal 204 tells STA1 to switch to the secondary 80 MHz of the BSS operating channel 202. Before the end of BSRP Trigger frame, STA1 switches to secondary 80 MH channel and sends the responding frame in secondary channel as indicated by the AP through BSRP Trigger frame. This is illustrated in a trigger based PHY protocol data unit (TB PPDU) that may include STA1 QoS null message 206 and STA2 QoS null message 208 that cover different 80 MHz bandwidths. Then a basic trigger 210 to solicit the A-MPDU from STA1 and STA2 in different RUs may be sent. In response the stations respond with a TB PPDU that includes STA1 aggregated MAC protocol data unit (A-MPDU) 212 and STA2 A-MPDU 214. Then a Multi-STA block acknowledge (BA) 216 or non-HT duplicate PPDU to indicate the end of the TXOP is sent. At this point STA1 may switch back to the primary 80 MHz channel of the BSS operating channel 202 to monitor the medium. Various aspects of this operation and how it might be implemented will now be discussed.

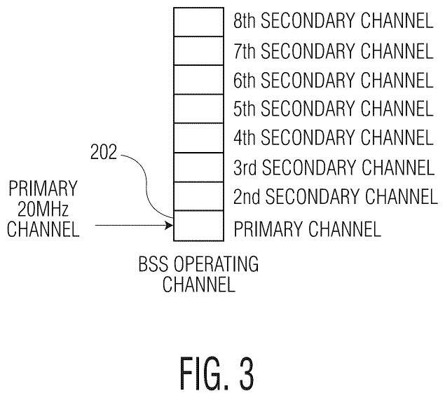

FIG. 3 illustrates the BSS operating channel 202 with one resource unit (RU) being assigned as the primary channel with the remaining 20 MHz RUs being assigned as the 2nd to the 8^{th} secondary channels. Now the RU in initial fame exchange for the dynamic channel switch vs the RU in the following frame exchanges will be described. In a TXOP a STA switches to the secondary channel(s) if the RU (RU1) being allocated to the STA in the initial frame exchange being not covered by STA's operating BW triggers the STA's dynamic channel switch and decides that the STA will switch to secondary channel(s). A STA whose operating channel cannot cover its allocated RU for CTS transmission needs to do the dynamic channel switch. The STA's parking in a secondary channel(s) is decided by the STA's current operating BW and the location of RU1, e.g. the secondary channel(s) with STA's current operating BW that covers RU1 configures a valid≥20 MHz channel (20 MHz, 40 MHZ, 80 MHz, 160 MHz etc.) per the allowed channelization. In a first example, in a 160 MHz BSS, if a 20 MHz STA acquires a 26-tone RU in the 8^{th} secondary channel (i.e. 8^{th} secondary 20 MHz channel) in a frame exchange that trigger the STA's dynamic channel switch in a TXOP, the STA parks in the 8^{th} secondary channel in the TXOP. In a second example, in a 160 MHz BSS, if a STA with 40 MHz operating BW acquires a 52-tone RU in the 5^{th} secondary channel in a frame exchange that trigger the STA's dynamic channel switch in a TXOP, the STA parks in the 5^{th}+6^{th} secondary channels in the TXOP. In a third example, for a 160 MHz BSS, if a STA with 80 MHz operating BW acquires a 52-tone RU in the 5^{th} secondary channel in a frame exchange that triggers the STA's dynamic channel switch in a TXOP, the STA parks in the 5^{th}+6^{th}+7^{th}+8^{th} secondary channels in the TXOP.

A few methods for carrying out DSO will now be described. In a first method, a STA that supports DSO and is associated with an AP enabling DSO, can negotiate whether the STA can enable its DSO. A padding delay for switching to parking channel(s) and the switch delay from parking channel to primary channel are announced by the STA during the negotiation. Each parking channel of a STA with >20 MHz operating BW can be wider than 20 MHz. One variant is that the parking channel has same BW as its operating BW. In one embodiment, more than one parking channel for a STA can be negotiated. As an example in a 320 MHz BSS, a 80 MHz STA can negotiate with the AP its parking channels in DSO operation to be 3rd 80 MHz channel in secondary 160 MHz channel and 4^{th} 80 MHz channel in in secondary 160 MHz channel. As an example in a 320 MHz BSS, a 80 MHz STA can negotiate with the AP its parking channels in DSO operation to be secondary 80 MHz channel in primary 160 MHz channel and 4^{th} 80 MHz channel in in secondary 160 MHz channel.

In a second method, any STAs that have an operating BW narrower than BSS operating BW can do a dynamic channel switch in a TXOP solicited by the AP.

In a third method, any STAs that have operating BW narrower than BSS operating BW and have an operating BW that is not narrower than a BSS subchannel can do a dynamic channel switch in a TXOP solicited by the AP. Any 20 MHz STAs can do dynamic channel switch in a TXOP solicited by the AP.

The use of a network allocation vector (NAV) timer with BW information will now be described. In FIG. 2, a NAV time for STA1 may be associated with the primary 80 MHz channel, but when STA1 dynamically switches channels, this NAV timer does not apply to the switched secondary channels, e.g. because the PPDU BW that sets the NAV timer is no more than 80 MHz. Per the baseline rules, if the Basic NAV Timer is not 0, the TXOP responder cannot transmit the responding frame although the TXOP responder switched to the secondary channels that are idle. One way to address this would be that a STA can maintain its Basic NAV timer associated with specific BW information. If the switched secondary channels of a STA are not covered by the BW of the STA's non-zero basic NAV timer and the PHY Controlled Channel Access (CCA) is within Short Frame Interface (SIFS) before transmitting, the responding frame indicates the medium of the switched secondary channels is idle, and the STA can transmit the responding frame. In this situation the Basic NAV Timer may operate as follows. If a received overlapped BSS (OBSS) PPDU BW is wider than the BW associated with the NAV timer, the BW of the basic NAV timer is set to the BW of the received OBSS PPDU. If the received OBSS frame or OBSS PPDU indicates a TXOP duration that is longer than the value of the basic NAV timer at the end of the received OBSS PPDU, the NAV timer is set to the Duration in received OBSS frame or the PHY header of the received OBSS PPDU at the end of the received PPDU. In one example, if a STA is requested by the AP in a TXOP to switch to its parking channel (secondary channel(s)) that is not covered by the Basic NAV timer's BW with non-zero NAV timer value, the STA switches to the parking channel and checks PHY CCA of 20 MHz channel(s) covering its RU. If the PHY CCA indicates medium idle on 20 MHz channel(s) covering its RU allocated by the AP, the STA transmits the responding frame in the allocated RU and stays on its parking channel until the end of the TXOP. In another example, if a STA is requested by the AP in a TXOP to switch to its parking channel (secondary channel(s)) that is covered by the Basic NAV timer's BW with non-zero NAV timer value, the STA stays in the primary channel and does not send the responding frame. In another example, if a STA is requested by the AP in a TXOP to switch to its parking channel (secondary channel(s)) and the STA's Basic NAV timer has zero value in its NAV timer (virtual carrier sensing idle), the STA switches to the parking channel and checks PHY CCA of 20 MHz channel(s) covering its RU. If the PHY CCA indicates medium idle on 20 MHz channel(s) covering its RU allocated by the AP, the STA transmits the responding frame in the allocated RU and stay on its parking channel until the end of the TXOP.

Under the DSO operation, the dynamic channel puncture may need some restriction. Otherwise a STA that does the dynamic channel switch may miss the RU allocated to it. The primary channel of a BSS started by an AP is never be punctured by the PPDUs transmitted by the AP. Without DSO, all the STAs can decode the AP's PPDU starting from the primary channel. With dynamic channel puncture, each secondary channel can be randomly punctured. When a STA selects a 20 MHz secondary channel in its parking channel to decode the PPDU from the AP and the AP punctures the 20 secondary channel, the STA will miss the PPDU. There are several methods to address the issue.

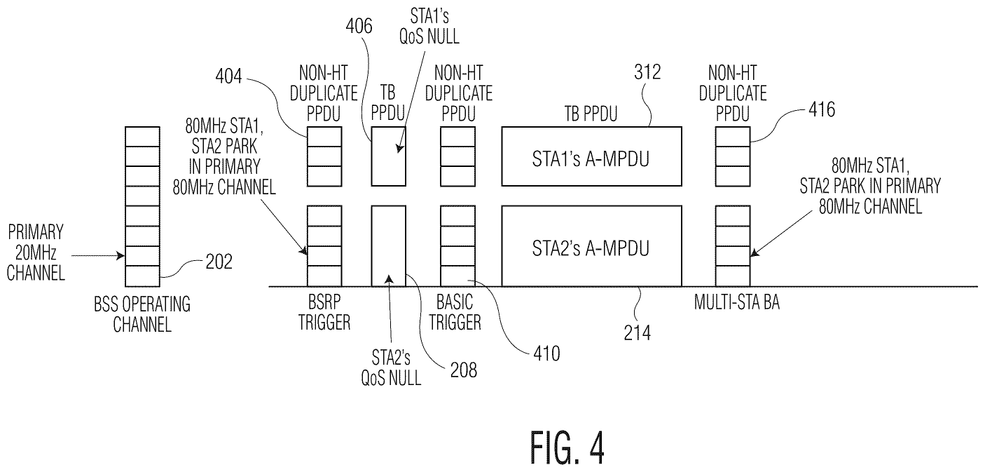

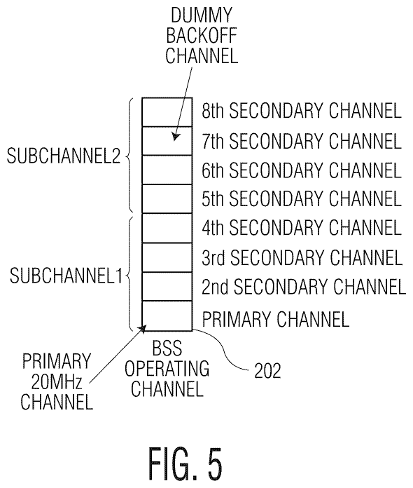

In a first method, in a TXOP, it is acceptable to carry out a dynamic channel puncture for the frame exchange (e.g., BSRP Trigger+QoS Null) that solicits the STAs to do a dynamic channel switch. In the following frame exchanges of the TXOP, the further channel puncture is not allowed, i.e. if, in a TXOP, a secondary 20 MHz channel is not punctured in the frame exchange that solicits the STAs to do a dynamic channel switch, the secondary 20 MHz channel cannot be punctured in the following frame exchanges. FIG. 4 illustrate this method. In the first frame exchange of the TXOP, the 5^{th} secondary 20 MHz channel is dynamically punctured in the PPDU 404 carrying the soliciting BSRP Trigger frame. In the remaining frame exchanges of the TXOP, all the other PPDUs only have the 5^{th} secondary 20 MHz channel being punctured. After the first frame exchange carrying by PPDU 404 and 406, STA1 that dynamically switches to the secondary 80 MHz channel tries to decode AP's PPDU starting from a 20 MHz channel in secondary 80 MHz channel other than the 5^{th} secondary 20 MHz channel, e.g. 6^{th} secondary 20 MHz channel. A variant to this is that the secondary channels on which no STAs switch dynamically can be punctured. In another example, in a TXOP, the 5^{th} and 6^{th} secondary channels are punctured in the frame exchange to request a STAs dynamic channel switch. The secondary channels other than the 5^{th} and 6^{th} secondary channels cannot be punctured in the following frame exchanges of the TXOP. Under this first method, if no STAs switch to the 2nd, 3rd, 4^{th} secondary channels, those secondary channels can be punctured in the following frame exchanges of the TXOP.

In second method, an AP announces the subchannels of its BSS where a subchannel includes multiple 20 MHz channels (primary channel and/or secondary channels). Each subchannel without primary channel has a dummy backoff channel (unpunctured 20 MHz channel) that is never punctured. Another variant is that each STA negotiates the unpunctured 20 MHz channel in its parking channel (wider than 20 MHz channel) when negotiating the enabling of its parking channel. In a TXOP, it is acceptable to carry out a dynamic channel puncture for the secondary channels other than the unpunctured 20 MHz channel(s) for the frame exchange (e.g., BSRP Trigger+QoS Null) that solicits the STAs to do dynamic channel switch. In the following frame exchanges of the TXOP, the further channel puncture is allowed for the secondary channels other than the unpunctured 20 MHz channel(s).

For a STA with operating BW that is more than 20 MHz and narrower than the width of the subchannel, in a first option the AP will not request the STA to do dynamic channel switch, in second option the AP will not request the STA to switch to the secondary channels that cover anchor channel, and in third option the AP can request the STA to switch to secondary channels that do not cover anchor channel and the AP will not further puncture the STA's parking secondary channels in the following frame exchanges of the TXOP.

In a third method, the dynamic channel puncture is not allowed in the frame exchanges with STAs switching to secondary channels.

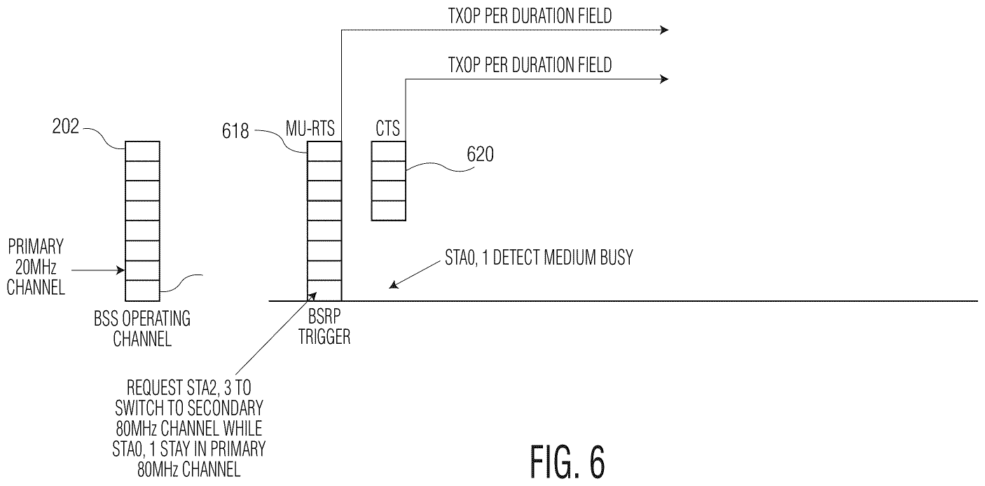

FIG. 6 illustrates the use of a MU-RTS frame as a control frame for initiating a dynamic channel switch. The MU-RTS 618 is the Control frame initiating the dynamic channel switch, and the MU-RTS 618 uses the RU allocated to a STA to indicate whether the STA needs to do the dynamic channel switch, e.g. when the allocated RU to a STA is not covered by the STA's operating BW. In one example, the 80 MHz operating BW of a 80 MHz STA will not cover the secondary 80 MHz channel. In the dynamic channel switch operation, some responding STAs may switch to secondary channels to transmit CTS frames 620 while one or multiple STAs transmit CTS frame(s) 620 in non-HT duplicate PPDU(s) that covers the primary channel. If no STAs transmits CTS frame(s) 620 (for example, STA0 and STA1 in FIG. 6, because the primary channels are in use) in non-HT duplicate PPDU(s) that covers the primary channel while the STAs switched to secondary channels transmit the CTS frame 620, the AP may assume the failed MU-RTS+CTS frame exchange, and the OBSS STAs/APs in secondary channel assume the medium busy. One exception is that if the AP can do the parallel PHY header decoding or can do the signal combination of multiple 20 MHz channels, the AP can detect the CTS frame 620 in the secondary channels although the primary channel has no responding CTS. A STA announces its padding delay for its dynamic channel switch from the primary channel to secondary channel. The padding time of the initiating frame for a STA being requested to do a dynamic channel switch is not less than the padding delay. As can be seen in FIG. 6, STA0 and STA1 have a TXOP that starts with the MU-RTS 618, and STA2 and STA3 have a TXOP that starts with the CTS 620.

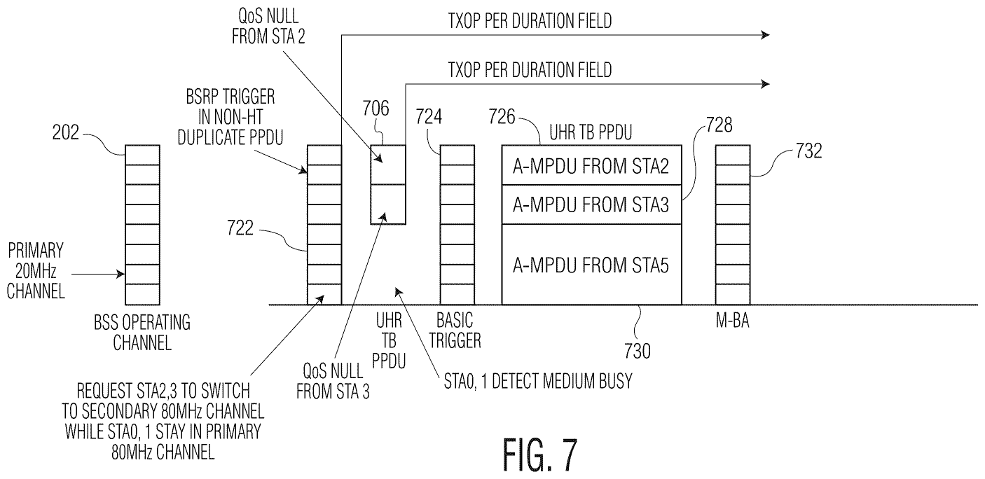

FIG. 7 illustrates the use of a BSRP/bandwidth query report poll (BQRP) trigger as a control frame for initiating the dynamic channel switch. BSRP/BQRP A trigger frame 722 in a non-HT duplicate PPDU may be used as the initiating control frame that uses the RU allocation for a STA to indicate whether the STA needs to do the dynamic channel switch. A STA whose operating channel (e.g. 80 MHz) cannot cover its allocated RU (e.g. in secondary 80 MHz channel) for QoS Null transmission in the TB PPDU needs to do the dynamic channel switch. In the case of FIG. 7, STA2 and STA3 need to do the dynamic channel switch. Accordingly, the QOS Null frames 706, 708 in two different RUs of TB PPDU of are sent by STA2 and STA3. The AP assumes the initial frame exchange of BSRP Trigger+QOS Null is successful. Then a Basic Trigger frame 724 in 160 MHz non-HT duplicate PPDU to solicit TB PPDU from STA2, STA3, STA5 is sent followed by the TB PPDU with the A-MPDU 726 from STA2, A-MPDU 728 from STA3, and A-MPDU 730 from STA5. Finally, a M-BA 732 is sent. The BSRP/BQRP Trigger 722+QoS Null 705 provide less protection because the responding QoS Null is carried in UHR TB PPDU. A STA announces its padding delay for its dynamic channel switch from the primary channel to secondary channel. The padding time of the initiating frame for a STA being requested to do dynamic channel switch is not less than the padding delay.

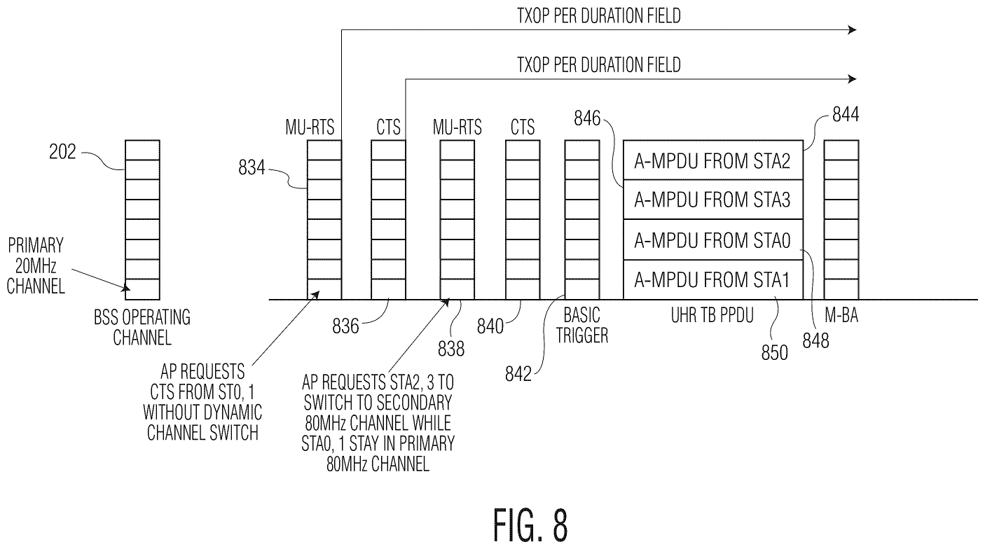

FIG. 8 illustrates a Double MU-RTS+CTS or MU-RTS+CTS followed by BSRP/BQRP Trigger+QoS Null. In FIG. 8, a MU-RTS 834 is sent that requests a CTS from STA0, STA1, STA2, and STA3 without a dynamic channel switch. Then CTS 836 is sent in response to MU-RTS 834. Then another MU_RTS 838 is sent requesting STA2 and STA3 to switch to a secondary 80 MHz channel while STA0 and STA1 stay in in a primary 80 MHz channel. Then CTS 840 is sent in response to MU-RTS 838. This is then followed by a basic trigger 842 followed by AP-MPDU's 844, 846, 848, and 850 for STA2, STA3, STA0, and STA1, respectively. This is followed by M-BA 848. An AP uses the first MU-RTS 834 to solicit CTS frames 836 from the STAs as the TXOP responders where each TXOP responder transmits the responding CTS to cover the primary channel although in the following frame some TXOP responders may dynamically switch to secondary channel(s). If the AP receives CTS 836 from at least one TXOP responder, the AP transmits another MU-RTS 838 or BSRP Trigger (or BQRP Trigger)+QoS Null to request some TXOP responders' dynamic channel switch.

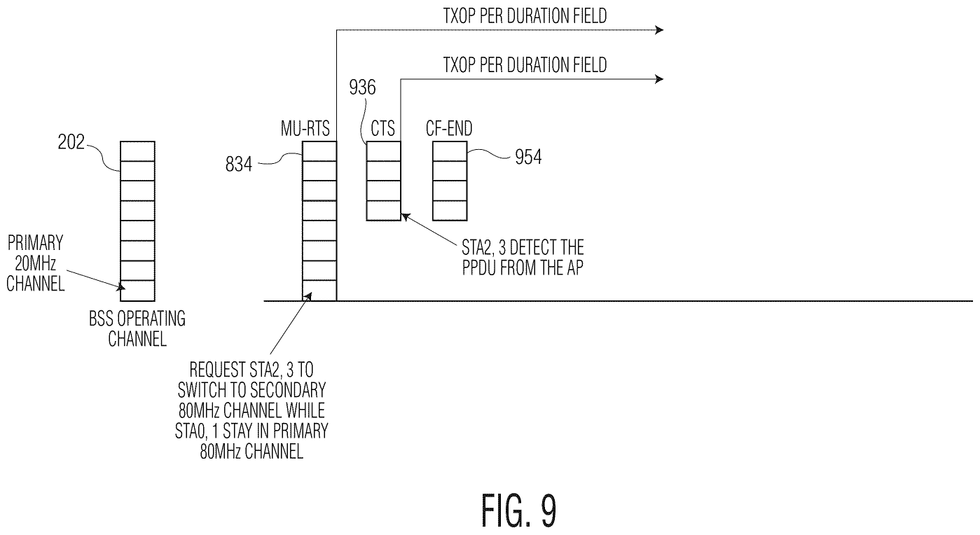

FIG. 9 illustrates how the STAs transmit a contention free end (CF-End) 954 to release the medium reserved by the AP. When a STA that switches to a secondary channel per the initiating MU-RTS 834 and transmits a CTS 936 in non-HT duplicate PPDU, but does not receive the following PPDU from the AP after a SIFS+one time slot or another defined interframe space (IFS), the STA can figure out that the AP misses the CTS being transmitted in secondary channels only. the STA can transmit CF-End 954 to let its neighbor STAs/APs know to reset their NAV timers. If a STA switched to the secondary channels to transmit the CF-End 954, the non-HT duplicate PPDU to carry the CF-End 954 has the same BW as the solicited CTS of the STA. The multiple STAs may transmit CF-End 954 at the same secondary channel. The same data rate (defined by the spec, e.g. 6 Mbps), scramble initial value (e.g. the scramble initial value of MU-RTS) need to be used by all the STAs that transmits the CF-End 954.

Switching back to the primary channel will now be described. At the end of the TXOP, a STA as the TXOP responder that switched to the secondary channel switches back to the primary channel. Another variant is that if a STA detects a failed frame exchange or received a frame that is not addressed to the STA, the STA switches back to the primary channel. One option is that this variant applies to EMLSR/EMLMR STA only, i.e., a STA that is not an EMLSR/EMLMR STA

Operations at the End of the TXOP will now be described. At the end of the TXOP, a STA that switches back to the primary channel does not need to do the medium synchronization. One variant is that if the time used to switch back to the primary channel is no more than a threshold (e.g., 72 us) after the last PPDU of the TXOP, the STA does not need to do the medium synchronization. A STA notifies the AP of its transition delay from secondary channel to the primary channel. An AP cannot schedule the STA within the transition delay starting at the end of the TXOP.

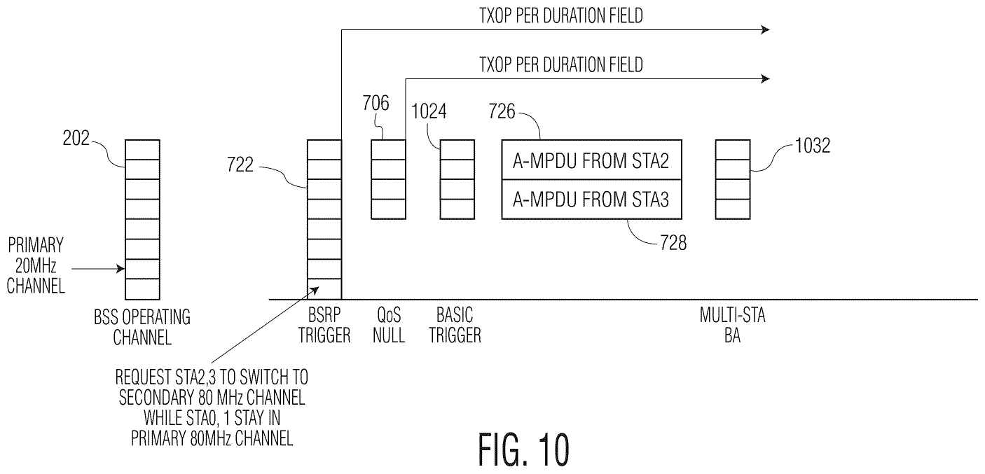

In a first embodiment, in each frame exchange of the TXOP with dynamic channel switch, the TXOP holder's PPDU needs to use the primary channel. At the end of the TXOP, a STA that switches back to the primary channel does not need to do the medium synchronization. A variant to this is that the AP announces whether the STAs switch to secondary channel needs to do medium synchronization after switching back to the primary channel. In a second embodiment, in a frame exchange of the TXOP with dynamic channel switch other than the initial frame exchange, it is ok that the TXOP holder's PPDU doesn't use the primary channel, and accordingly the responding PPDU will not use the primary channel. At the end of the TXOP, a STA that switches back to the primary channel needs to do the medium synchronization. FIG. 10 illustrates the second embodiment under DSO where the frame exchanges after the first frame exchange for channel switch do not need to use the primary channel. When no TXOP responder uses the primary channel, both the AP and the STAs may lose the medium usage information of the primary channel. In the figure, a BSRP Trigger 722 in non-HT duplicate PPDU is sent that requests STA2 and STA3 to switch to a secondary 80 MHz channel while STA0 and STA1 stay in the primary 80 MHz channel to transmit CTS frames in four different RUs of TB PPDU by the four TXOP responders. Two QoS Null frames 706, 708 from STA2 and STA3 are sent in response to the BSRP Trigger 722. Then a Basic Trigger 1024 in non-HT duplicate PPDU covering the secondary 80 MHz channel is sent followed by A-MPDU from STA2 726 and A-MPDU from STA3 728 in two RUs of TB PPDU. This is the followed by a Multi-STA BA 1032.

Dynamic channel switch, power save and in-device interference mitigation will now be described. With MU-RTS/CTS for low-capacity power save, the TXOP responder that uses a 20 MHz BW and one spatial stream (SS) switches to its full capacity at the end of the non-HT duplicate PPDU frame carrying MU-RTS and uses its full capacity after responding with a CTS in the RU announced by the AP. The related STA announces its padding delay for dynamic channel switch and low-power capacity mode to full-power capacity mode. With the updated MU-RTS/CTS for low-capacity power save where the updated MU-RTS (or another new defined initial control frame) to indicate the expected responder's capacity, the TXOP responder that uses a 20 MHz BW and one SS switches to the expected capacity requested by the AP at the end of the non-HT duplicate PPDU carrying the MU-RTS and uses the expected capacity after responding with CTS in the RU announced by the AP. The related STA announces its padding delay for dynamic channel switch and low-power capacity mode to full-power capacity mode. The expected capacity is not more than the STA's full capacity (operating BW, number of special streams (Nss)). With BSRP/BQRP Trigger+QoS Null (or the newly defined initial control frame+responding control frame), a STA with in-device non-WiFi radio can do dynamic channel switching and notify its available/unavailable time period and the other restriction. For a QoS Null solicited by a BSRP/BQRP Trigger, the HE Control field is used to carry the available/unavailable time period and the other restriction. For the new defined control responding frame, the frame body of the responding control frame is used to carry the available/unavailable time period and the other restriction. The new defined control responding frames are carried in UHR TB PPDU. Another variant is to use BSRP/BQRP Trigger+Multi-STA BA instead of BSRP/BQRP Trigger+QoS Null.

The foregoing disclosure provides illustration and description but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Unless otherwise indicated, all numbers expressing parameter values and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by embodiments of the present disclosure. As used herein, “about” may be understood by persons of ordinary skill in the art and can vary to some extent depending upon the context in which it is used. If there are uses of the term which are not clear to persons of ordinary skill in the art, given the context in which it is used, “about” may mean up to plus or minus 10% of the particular term.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method of method of dynamic channel switching by a station (STA), comprising:
receiving a resource unit (RU) allocation in an initial frame exchange;
determining that the STA cannot operate in its operating BW covering a primary channel based upon the RU allocation;
switching to secondary channel(s) per an RU allocated to it to carry out communication by the STA during a transmit opportunity (TXOP);
carrying out the communication during the TXOP; and
switching back to the primary channel no later than an end of the TXOP if detecting that an AP will not do the initial frame exchange with it in the secondary channel(s) within the TXOP.

2. The method of claim 1, further comprising:
negotiating by the STA whether the STA enables dynamic channel switching, parking channel(s) after switching to secondary channel(s) wherein each parking channel includes one or multiple secondary channels; and
announcing a padding delay for switching to the secondary channel and a switch delay from the secondary channel back to the primary channel.

3. The method of claim 2, further comprising:
each parking channel has a same bandwidth as the STA's operating BW.

4. The method of claim 2, further comprising:
each parking channel has a narrower bandwidth than the STA's operating BW.

5. The method of claim 1, wherein STA carries out a dynamic channel switch when the STAs operating bandwidth is narrower than a basic service set bandwidth.

6. The method of claim 1, wherein the STA has a bandwidth associated with a basic network allocation vector (NAV) timer.

7. The method of claim 6, wherein a received Physical Layer Convergence Protocol (PLCP) Protocol Data Unit (PPDU) bandwidth is from another Basic Service Set (BSS) and is greater than the bandwidth associated with the basic NAV timer, set the bandwidth associated with the basic NAV time to a received STA bandwidth.

8. The method of claim 6, wherein a duration information in a media access control (MAC) header and/or PHY header of a received PPDU from another BSS is greater than a remaining time of the basic NAV timer, set the remaining time of the basic NAV timer to the duration information in MAC header and/or PHY header of the received PPDU.

9. The method of claim 6, if the basic NAV timer of a STA has non-zero remaining time and has the bandwidth that can cover an allocated RU that request STA's dynamic channel switch, the STA does not do a dynamic channel switch.

10. The method of claim 1, further comprising carrying out a dynamic channel puncture during the initial frame exchange that solicits the dynamic channel switching.

11. The method of claim 10, wherein if a 20 MHz channel is not punctured in the initial frame exchange that solicits the dynamic channel switching, the 20 MHz channel is not punctured in a following frame exchanges of the TXOP.

12. The method of claim 1, further comprising
specifying an anchor channel that is a secondary channel; and
carrying out a dynamic channel puncture for secondary channels other than the anchor channel during the initial frame exchange that solicits the dynamic channel switching and a following frame exchanges of the TXOP.

13. The method of claim 1, wherein the initial frame exchange uses a multi-user request to send message to solicit CTS as the initial frame exchange to initiate a dynamic channel switch.

14. The method of claim 13, wherein the STA transmits a contention free end (CF-End) message after switching to the secondary channel when the STA does not receive a following Physical Layer Convergence Protocol (PLCP) Protocol Data Unit from an access point after the initial frame exchange.

15. The method of claim 1, wherein the initial frame exchange uses a buffer status report poll (BSRP) Trigger message to solicit a Quality of Service (QOS) Null as the initial frame exchange to initiate a dynamic channel switch.

16. The method of claim 15, wherein each frame exchange after the initial frame exchange always covers the primary channel with primary channel being not punctured.

17. The method of claim 16, wherein the STA does not perform media synchronization after switching back to the primary channel.

18. The method of claim 1, wherein the initial frame exchange uses a double multi-user request to send plus clear to send messages followed by a buffer status report poll (BSRP) Trigger message plus a quality of service Null message to initiate a dynamic channel switch.

19. The method of claim 1, wherein the STA switches back to the primary channel after the TXOP ends.

20. The method of claim 19, wherein the STA is not an enhanced multi-link single radio (EMLSR) STA.

21. The method of claim 1, wherein the STA switches back to the primary channel after the STA detects a failed frame exchange with it, or detects a frame exchange that does not include it.

22. The method of claim 19, wherein the STA is an enhanced multi-link single radio (EMLSR) STA.

23. An station (STA) for communicating with an access point (AP), comprising a processor configured to:
receive a resource unit (RU) allocation in an initial frame exchange;
determine that the STA cannot operate in its operating BW covering a primary channel based upon the RU allocation;
switch to secondary channel(s) per an RU allocated to it to carry out communication by the STA during a transmit opportunity (TXOP);
carry out the communication during the TXOP; and
switch back to the primary channel no later than an end of the TXOP if detecting that the AP will not do the initial frame exchange with it in a secondary channel(s) within the TXOP.
